(19) United States
(12) Patent Application Publication
(10) Pub. No.: US 2025/0252649 A1
(43) Pub. Date: Aug. 7, 2025

(54) IMAGE RENDERING METHOD AND APPARATUS, DEVICE, AND STORAGE MEDIUM

(71) Applicant: Beijing Zitiao Network Technology Co., Ltd., Haidian District, Beijing (CN)

(72) Inventor: Qi YUAN, Beijing (CN)

(21) Appl. No.: 18/860,839

(22) PCT Filed: Mar. 9, 2023
(86) PCT No.: PCT/CN2023/080544

§ 371 Date: Oct. 28, 2024

(30) Foreign Application Priority Data
Apr. 29, 2022 (CN) 202210475983.9

(51) Int. Cl. G06T 15/00

(52) U.S. Cl. CPC G06T 15/005; G06T 2215/12

(57) ABSTRACT

An image rendering method and apparatus, a device, and a storage medium are provided. The image rendering method includes: obtaining an object depth map and an object normal map of a target object in an image; determining occlusion information based on the object depth map; determining illumination information based on the object normal map; and rendering the target object in the image based on the occlusion information and the illumination information to obtain a target image.

The present application claims priority to and benefit of Chinese Patent Application No. 202210475983.9 filed on Apr. 29, 2022, the disclosure of which is incorporated herein by reference as part of the present application in its entirety.

### TECHNICAL FIELD

Embodiments of the present disclosure relate to the technical field of image rendering, e.g., to an image rendering method and apparatus, a device, and a storage medium.

### BACKGROUND

In the related art, when illumination rendering is performed on a three-dimensional body, three-dimensional modeling is required, and an overall model of the body needs to be created. This way has the disadvantages of a large amount of computation and low efficiency. When occlusion information of a three-dimensional object is rendered, a three-dimensional model of a part of the object needs to be used for rendering with a set material to achieve an occlusion effect. This method requires pre-establishment of a three-dimensional occlusion model of a particular body part, and the established model does not necessarily conform to a plurality of object forms, leading to a poor occlusion effect.

### SUMMARY

Embodiments of the present disclosure provide an image rendering method and apparatus, a device, and a storage medium. Illumination information and occlusion information of a body may be realistically rendered. Not only can the rendering efficiency of an object be improved, but also a rendering effect can be improved.

In a first aspect, an embodiment of the present disclosure provides an image rendering method, including:
obtaining an object depth map and an object normal map of a target object in an image;
determining occlusion information based on the object depth map;
determining illumination information based on the object normal map; and
rendering the target object in the image based on the occlusion information and the illumination information to obtain a target image.

In a second aspect, an embodiment of the present disclosure further provides an image rendering apparatus, including:
a depth map and normal map obtaining module configured to obtain an object depth map and an object normal map of a target object in an image;
an occlusion information determination module configured to determine occlusion information based on the object depth map;
an illumination information determination module configured to determine illumination information based on the object normal map; and
a rendering module configured to render the target object in the image based on the occlusion information and the illumination information to obtain a target image.

In a third aspect, an embodiment of the present disclosure further provides an electronic device, including:
one or more processing apparatuses; and
a storage apparatus configured to store one or more programs,
where the one or more programs, when executed by the one or more processing apparatuses, cause the one or more processing apparatuses to implement the image rendering method as described in the embodiments of the present disclosure.

In a fourth aspect, an embodiment of the present disclosure further provides a computer-readable medium, storing a computer program, where the computer program, when executed by a processing apparatus, causes implementing the image rendering method as described in the embodiments of the present disclosure.

### BRIEF DESCRIPTION OF DRAWINGS

FIG. 1 is a flowchart of an image rendering method in an embodiment of the present disclosure;

FIG. 2 is a structural schematic diagram of an image rendering apparatus in an embodiment of the present disclosure; and

FIG. 3 is a structural schematic diagram of an electronic device in an embodiment of the present disclosure.

### DETAILED DESCRIPTION

It should be understood that a plurality of steps described in the method implementations of the present disclosure may be performed in different orders and/or concurrently. In addition, the method implementations may include additional steps and/or the steps shown may be omitted. The scope of the present disclosure is not limited in this aspect.

As used herein, the term “include” and variants thereof are open words and should be construed as “including but not limited to”. The term “based on” means “at least in part based on”. The term “one embodiment” represents “at least one embodiment”; the term “another embodiment” represents “at least one further embodiment”; and the term “some embodiments” represents “at least some embodiments”. The relevant definitions of other terms will be given in the following descriptions.

It should be noted that terms such as “first” and “second” are used for distinguishing between different apparatuses, modules or units rather than defining the sequence or interdependent relation of functions performed by such apparatuses, modules or units.

It should be noted that terms such as “a/an” and “a plurality of” used herein are illustrative and non-limiting. It should be understood by a person skilled in the art that “a/an” shall be construed as “one or more” unless specified otherwise.

Names of messages or information exchanged between a plurality of apparatuses in embodiments of the present disclosure are only used for the purpose of description and not meant to limit the scope of these messages or information.

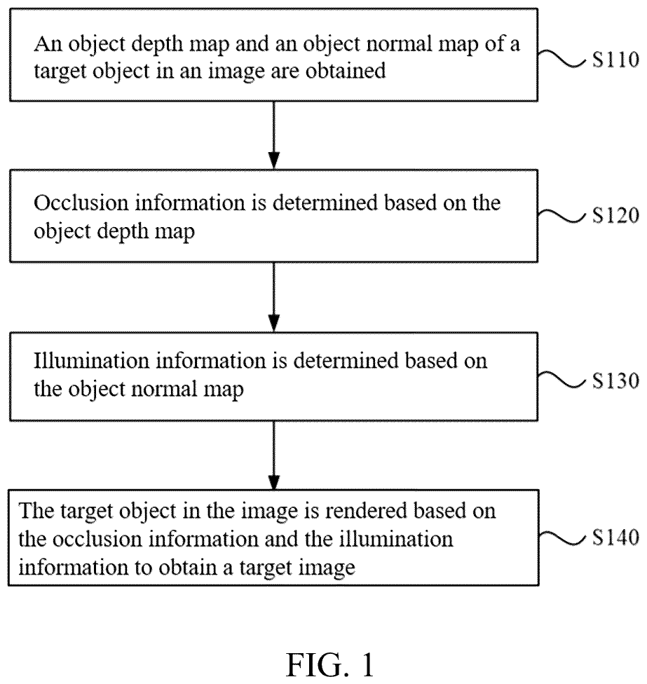

FIG. 1 is a flowchart of an image rendering method provided by an embodiment of the present disclosure. This embodiment may be applicable to a case where a target object is rendered based on illumination information and occlusion information. The image rendering method may be performed by an image rendering apparatus which may be implemented by hardware and/or software and may be generally integrated into a device with an image rendering function. The device may be an electronic device such as a server, a mobile terminal, or a server cluster. As shown in FIG. 1, the image rendering method includes the following steps.

At S110, an object depth map and an object normal map of a target object in an image are obtained.

The target object may be any object selected according to a rendering requirement, for example, a human body, an animal (a cat or a dog, etc.), a plant, or a building, etc. The object depth map may characterize depth information constituting a 3D point of the target object, and a gray value of each pixel in the depth map represents a depth value of the corresponding 3D point. The object normal map may characterize normal information constituting the 3D point of the target object, and a gray value of each pixel in the normal map represents a normal vector of the corresponding 3D point. The normal vector may be three-dimensional coordinates, which are mapped to values of three color channels (RGB) in the normal map.

In this embodiment, a geometric feature of the target object (e.g., a human body) in the image may be determined using a geometric estimation algorithm in the related art, thereby obtaining the object depth map and the object normal map. A way of obtaining the object depth map and the object normal map is not defined in this embodiment.

At S120, occlusion information is determined based on the object depth map.

The occlusion information may include an occlusion relationship between the target object and a scene body. The occlusion relationship includes the target object being occluded by the scene body and the target object is not occluded by the scene body. In this embodiment, it is also necessary to obtain depth maps of other bodies in the scene where the target object is located, and the occlusion information is determined based on the depth maps of other bodies and the object depth map.

For example, a way of determining the occlusion information based on the object depth map may include: obtaining a body depth map of a scene where the target object is located; and determining the occlusion information based on the body depth map and the object depth map.

A way of obtaining the body depth map of the scene where the target object is located may include photographing the scene using a depth camera, thus obtaining the body depth map. After the body depth map is obtained, corresponding depth values in the body depth map and the object depth map are compared, and an occlusion relationship between the target object and other body is determined based on a comparison result. In this embodiment, the occlusion relationship between the target object and other body are determined based on two depth maps so that the accuracy of determining the occlusion information can be improved.

For example, a way of determining the occlusion information based on the body depth map and the object depth map may include: obtaining a near-plane depth value and a far-plane depth value of a camera; performing linear transformation on a depth value in the object depth map based on the near-plane depth value and the far-plane depth value; and determining the occlusion information based on the body depth map and the object depth map after the linear transformation.

The near-plane depth value and the far-plane depth value may be obtained directly from the configuration information of the camera. Performing linear transformation on the depth value in the object depth map may be construed as transforming the depth value to a range of the near-plane depth value and the far-plane depth value. For example, a formula of performing linear transformation on the depth value may be as: expressed

$$L ( d ) = \frac{2 * zNear * zFar}{( zFar + zNear - ( 2 d - 1 ) * ( zFar - zNear ) )} ,$$

where L(d) represents the depth value after the linear transformation; d represents the depth value before the linear transformation; zNear represents the near-plane depth value; and zFar represents the far-plane depth value. In this embodiment, the depth value is transformed to the range of the near-plane depth value and the far-plane depth value so that the accuracy of the occlusion information can be improved.

For example, before obtaining the near-plane depth value and the far-plane depth value of the camera, the image rendering method further includes the following step: mapping the depth value in the object depth map to a set depth interval.

The set depth interval may be set by the developer, which will not be defined here. In this embodiment, in order to facilitate subsequent depth testing processing, the depth value needs to be mapped to the set depth interval. For example, mapping the depth value in the object depth map to the set depth interval may be performed according to the following formula: H(d)=0.1*(1−d)+a, where H(d) represents the depth value after mapping; d represents the depth value before mapping; a represents a depth parameter, which is a constant and may be any value between 0.7 and 1, e.g., 0.8. A mapping formula may be expressed as: H(d)=0.1*(1−d)+0.8. Correspondingly, the process of performing linear transformation on the depth value in the object depth map based on the near-plane depth value and the far-plane depth value may include: performing linear transformation on the depth value in the object depth map that is within the set depth interval based on the near-plane depth value and the far-plane depth value.

For example, firstly, the depth value in the object depth map is mapped to the set depth interval; linear transformation is then performed on the depth value in the object depth map that is within the set depth interval based on the near-plane depth value and the far-plane depth value; and finally, the occlusion information is determined based on the body depth map and the object depth map after the linear transformation.

In this embodiment, the way of determining the occlusion information based on the body depth map and the object depth map may include: determine that the 3D point of the target object is not occluded if the depth value in the body depth map is greater than the corresponding depth value in the object depth map; and determine that the 3D point of the target object is occluded by a body if the depth value in the body depth map is less than the corresponding depth value in the object depth map.

Pixels in the body depth map are in one-to-one correspondence with pixels in the object depth map, and two corresponding pixels are in the same depth direction in the scene. If the depth value in the body depth map is greater than the corresponding depth value in the object depth map, it indicates that the scene body is further from the camera, and during rendering, only the target object is rendered in the depth direction with no need to render the scene body. If the depth value in the body depth map is less than the corresponding depth value in the object depth map, it indicates that the scene body is closer to the camera, and during rendering, only the scene body is rendered in the depth direction with no need to render the target object. Alternatively, the rendered scene body is superposed onto the target object, and an effect of the scene body occluding the target object is presented. In this embodiment, the occlusion relationship is determined by comparing the corresponding depth values in the two depth maps so that the accuracy of determining the occlusion information can be improved.

At S130, illumination information is determined based on the object normal map.

The illumination information may be construed as an illumination value corresponding to the 3D point on the target object. Color values (RGB) of each pixel in the object normal map represent three components of the normal vector. In this embodiment, after the object normal map is obtained, a location of a light source and location information constituting the 3D point of the target object also need to be obtained. An illumination direction of the 3D point is determined based on the location of the light source and the location information of the 3D point, and the illumination information of the 3D point is determined based on the illumination direction and normal information in the object normal map.

For example, a way of determining the illumination information based on the object normal map may include: smoothing the normal information in the object normal map; obtaining the illumination direction of the 3D point of the target object; and determining the illumination information of the 3D point based on the illumination direction and the smoothed normal information.

A way of smoothing the normal information in the object normal map may include: for a current pixel, calculating an average value of the normal information of the current pixel and normal information of 8 neighborhood pixels thereof as the final normal information of the current pixel. When the average value is calculated, average values are calculated for three color values, respectively.

The illumination direction may be construed as a direction in which light emitted by the light source irradiates on the 3D point. That is, the direction in which the light is incident on the 3D point is the illumination direction. For example, a way of obtaining the illumination direction of the 3D point of the target object may include: obtaining first location information of the 3D point of the target object and second location information of the light source; and determining the illumination direction of the 3D point based on the first location information and the second location information.

The light source may be construed as a virtual light source. The number of light sources may be 1 or more. The first location information may be construed as coordinate information of the 3D point in a camera coordinate system, and the second location information may be construed as coordinate information of the virtual light source in the camera coordinate system.

In this embodiment, a way of obtaining the first location information of the 3D point of the target object may include: transforming two-dimensional surface map UV coordinates of the target object to four-dimensional cutting space coordinates; transforming the four-dimensional cutting space coordinates to four-dimensional camera space coordinates; performing homogeneous transformation on the four-dimensional camera space coordinates, and transforming the z-coordinate after the homogeneous transformation to the depth value in the object depth map; and determining the first location information of the 3D point based on the transformed four-dimensional camera space coordinates.

Four dimensions include an x-coordinate, a y-coordinate, a z-coordinate, and a w-coordinate. UV coordinates may be a two-dimensional vector of which a value range is [0, 1]. Transforming the two-dimensional surface map UV coordinates of the target object to the four-dimensional cutting space coordinates may be realized using the following formula: clipPos(x,y,z,w)=(UV*2−1,−1,1), where clipPos(x,y,z,w) represents a four-dimensional cutting space. The process of transforming the four-dimensional cutting space coordinates to the four-dimensional camera space coordinates may include: premultiplying the four-dimensional cutting space coordinates by a transformation matrix from a screen coordinate system to the camera coordinate system, which may be expressed as: viewPos(x,y,z,w)−M1*clipPos, where M1 represents the transformation matrix from the screen coordinate system to the camera coordinate system. Performing homogeneous transformation on the four-dimensional camera space coordinates may be construed as dividing four components of the four-dimensional camera space coordinates by the w component, which may be expressed as: viewPos=viewPos/viewPos.w. Transforming the z-coordinate after the homogeneous transformation to the depth value in the object depth map may be construed as transforming the z-coordinate after the homogeneous transformation to the depth value after the linear transformation. Finally, the x component, the y component, and the z component of the transformed four-dimensional camera space coordinates are extracted as the first location information of the 3D point. In this embodiment, the UV coordinates are transformed to obtain the three-dimensional coordinates of the 3D point under the camera coordinate system so that the location information of the 3D point can be accurately determined.

For example, a way of determining the illumination direction of the 3D point based on the first location information and the second location information may include: subtracting the three-dimensional coordinates corresponding to the second location information from the three-dimensional coordinates corresponding to the first location information to obtain the illumination direction. It may be expressed as: lightDir(x,y,z)−viewPos−planetPos, where viewPos represents the three-dimensional coordinates of the 3D point, i.e., the first location information, and planetPos represents the three-dimensional coordinates of the light source, i.e., the second location information. In this embodiment, the illumination direction may be determined accurately based on the location information of the light source and the location information of the 3D point.

For example, the process of determining the illumination information of the 3D point based on the illumination direction and the smoothed normal information may include: multiplying a vector corresponding to the illumination direction by a vector corresponding to the normal information to obtain an initial illumination value; if the initial illumination value is greater than a first set value, multiplying the initial illumination value by a first set illumination value to obtain a target illumination value; and if the initial illumination value is less than or equal to the first set value, multiplying the initial illumination value by a second set illumination value to obtain the target illumination value.

The first set value can be 0. The first set illumination value may be a preset illumination color value, which may be denoted by lightColor. The second set illumination value may be a preset tiny value, e.g., 0.01. In this embodiment, firstly, the vector corresponding to the illumination direction and the vector corresponding to the normal information are standardized separately, and then the standardized vector corresponding to the illumination direction is multiplied by the standardized vector corresponding to the normal information to obtain the initial illumination value glare. If glare is greater than 0, glare is multiplied by lightColor to obtain the target illumination value light. If glare is small than or equal to 0, glare is multiplied by 0.01 to obtain the target illumination value light. In this embodiment, if glare is less than or equal to 0, glare is multiplied by 0.01 to obtain a small target illumination value. Thus, a light spot may be avoided.

In this embodiment, the illumination value may decrease with an increasing distance from the light source, and therefore, the determined target illumination value needs to be corrected. For example, after the target illumination value is obtained, the image rendering method further includes the following steps: determining the distance of the light source from the 3D point of the target object; determining illumination attenuation information based on the distance; and adjusting the target illumination value based on the illumination attenuation information.

In this embodiment, the attenuation of the illumination value may be simulated by using an illumination attenuation effect approximate to the spotlight effect in a screen space. The distance of the light source from the 3D point of the target object may be construed as the distance of the light source from the 3D point under the screen coordinate system.

For example, the process of determining the distance of the light source from the 3D point of the target object may include: transforming the second location information of the light source to screen coordinates to obtain second screen coordinate information; transforming the first location information of the 3D point of the target object to the screen coordinates to obtain first screen coordinate information; and determining the distance of the light source from the 3D point of the target object based on the second screen coordinate information and the first screen coordinate information.

A way of transforming the second location information of the light source to the screen coordinates may include: firstly premultiplying the three-dimensional coordinates corresponding to the second location information by a second transformation matrix (a transformation matrix from the camera coordinate system to the screen coordinate system) to obtain coordinates after projection transformation; and then performing linear transformation on the x component and the y component of the coordinates after projection transformation to obtain the coordinate information of the light source in the screen, i.e., the second screen coordinate information. It may be expressed as: samplePos(x,y,z)=M2*(x,y,z,1), sampleUV.x=samplePos.x*0.5+0.5, sampleUV.y=samplePos.y*(−1)*0.5+0.5, by which the second screen coordinate information sampleUV(x,y) is obtained.

A way of transforming the first location information of the 3D point of the target object to the screen coordinates may include: dividing the x component of the two-dimensional surface map UV coordinates of the target object by a length of the screen along an x direction and dividing the y component by a length of the screen along a y direction, i.e., transforming the UV coordinates of the target object to values between 0 and 1, thereby obtaining the first screen coordinate information. In this embodiment, since the first location information of the 3D point is transformed from the UV coordinates of the target object, the first screen coordinate information may be determined directly from the UV coordinates of the target object.

For example, the distance of the light source from the 3D point of the target object may be determined based on the second screen coordinate information and the first screen coordinate information using any distance formula.

In this embodiment, after the distance of the light source from the 3D point of the target object is obtained, the illumination attenuation information may be calculated according to the following formula:

$$A = {( 1 - \frac{dist}{r} )}^{s} ,$$

where dist represents the distance; r represents a halo radius; s represents an attenuation coefficient of halo; and r and s are set values. For example, adjusting the target illumination value based on the illumination attenuation information may be realized according to the following formula: L=light*i*A, where i represents an intensity, which is a set value; A represents an attenuation value; and light represents the target illumination value. In this embodiment, the attenuation information is determined based on the distance of the light source from the 3D point to correct the illumination value so that the authenticity of the illumination information can be improved.

At S140, the target object in the image is rendered based on the occlusion information and the illumination information to obtain a target image.

For example, the obtained occlusion information and illumination information are input to a rendering engine to render the target object in the image to obtain the target image.

For example, after rendering the target object in the image based on the occlusion information and the illumination information to obtain a target image, the image rendering method further includes the following steps: obtaining initial map UV coordinates of a set special effect; transforming the initial map UV coordinates based on a current time to obtain intermediate UV coordinates; performing polar coordinate transformation on the intermediate UV coordinates to obtain target UV coordinates; and rendering set special effect based on the target UV coordinates, and superimposing the rendered set special effect onto the target object.

Transforming the initial UV coordinates may be construed as scaling and/or translating the initial UV coordinates. Transforming the initial map UV coordinates based on the current time may be construed as determining a scaling quantity and/or a translational quantity based on the current time. Exemplarily, the initial UV coordinates may be transformed using the following formula: UV1=UV0*scale+time*speed, where UV1 represents the intermediate UV coordinates; scale represents a scaling matrix; time represents the current time; and speed represents a translational speed. An effect of the set special effect changing with time may be presented by transforming the initial map UV coordinates based on the current time.

Performing polar coordinate transformation on the intermediate UV coordinates may be realized according to the following formula:

$$ρ = \sqrt{{x}^{2} + {y}^{2}} , tan θ = \frac{y}{x} ,$$

where (x,y) represents the intermediate UV coordinates; and (ρ, θ) represents the target UV coordinates after the polar coordinate transformation. In this embodiment, an effect of a circular arc may be presented by performing polar coordinate transformation on the UV coordinates.

For example, the target UV coordinates of the set special effect are input to the rendering engine for rendering, and the rendered set special effect is superimposed onto the target object such that the set special effect is added to the target object.

For example, for the color values of each point in the UV map in the set special effect, attenuation adjustment may also be performed on the color values by the way of determining the illumination attenuation information as described in the above embodiment. The process may include: calculating a distance of each point in the target UV map from the light source, determining color attenuation information based on the distance, and adjusting the color values based on the color attenuation information.

According to the technical solution of this embodiment of the present disclosure, the object depth map and the object normal map of the target object in the image are obtained; the occlusion information is determined based on the object depth map; the illumination information is determined based on the object normal map; and the target object in the image is rendered based on the occlusion information and the illumination information to obtain the target image. According to the image rendering method provided by this embodiment of the present disclosure, the occlusion information is determined based on the object depth map, and the illumination information is determined on the object normal map. The illumination information and the occlusion information of a body may be realistically rendered. Not only can the rendering efficiency of an object be improved, but also a rendering effect can be improved.

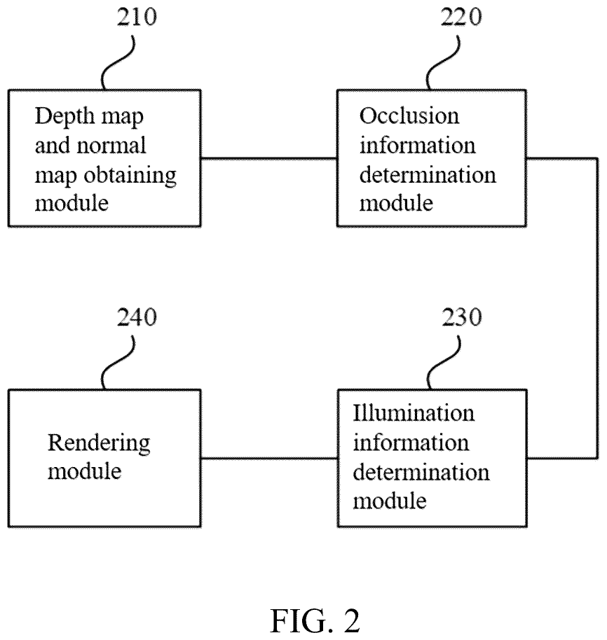

FIG. 2 is a structural schematic diagram of an image processing apparatus disclosed in an embodiment of the present disclosure. As shown in FIG. 2, the image processing apparatus includes:
a depth map and normal map obtaining module 210 configured to obtain an object depth map and an object normal map of a target object in an image;
an occlusion information determination module 220 configured to determine occlusion information based on the object depth map;
an illumination information determination module 230 configured to determine illumination information based on the object normal map; and
a rendering module 240 configured to render the target object in the image based on the occlusion information and the illumination information to obtain a target image.

For example, the occlusion information determination module 220 is further configured to:
obtain a body depth map of a scene where the target object is located; and
determine the occlusion information based on the body depth map and the object depth map.

For example, the occlusion information determination module 220 is further configured to:
obtain a near-plane depth value and a far-plane depth value of a camera;
perform linear transformation on a depth value in the object depth map based on the near-plane depth value and the far-plane depth value; and
determine the occlusion information based on the body depth map and the object depth map after the linear transformation.

For example, the occlusion information determination module 220 is further configured to:
map a depth value in the object depth map to a set depth interval,
perform linear transformation on the depth value in the object depth map that is within the set depth interval based on the near-plane depth value and the far-plane depth value.

For example, the occlusion information includes an occlusion relationship between the target object and a scene body; and the occlusion information determination module 220 is further configured to:
determine that a 3D point of the target object is not occluded if a depth value in the body depth map is greater than a corresponding depth value in the object depth map; and
determine that the 3D point of the target object is occluded by a body if the depth value in the body depth map is less than the corresponding depth value in the object depth map.

For example, the illumination information determination module 230 is further configured to:
smooth normal information in the object normal map;
obtain an illumination direction of the 3D point of the target object; and
determine illumination information of the 3D point based on the illumination direction and the smoothed normal information.

For example, the illumination information determination module 230 is further configured to:
obtain first location information of the 3D point of the target object and second location information of a light source; and
determine illumination direction of the 3D point based on the first location information and the second location information.

For example, the illumination information determination module 230 is further configured to:
transform two-dimensional surface map UV coordinates of the target object to four-dimensional cutting space coordinates, where four dimensions include an x-coordinate, a y-coordinate, a z-coordinate, and a w-coordinate;
transform the four-dimensional cutting space coordinates to four-dimensional camera space coordinates;
perform homogeneous transformation on the four-dimensional camera space coordinates, and transform the z-coordinate after the homogeneous transformation to the depth value in the object depth map; and
determine the first location information of the 3D point based on the transformed four-dimensional camera space coordinates.

For example, the illumination information determination module 230 is further configured to:
multiply a vector corresponding to the illumination direction by a vector corresponding to the normal information to obtain an initial illumination value;
if the initial illumination value is greater than a first set value, multiply the initial illumination value by a first set illumination value to obtain a target illumination value; and
if the initial illumination value is less than or equal to the first set value, multiply the initial illumination value by a second set illumination value to obtain the target illumination value.

For example, the illumination information determination module 230 is further configured to:
determine a distance of the light source from the 3D point of the target object;
determine illumination attenuation information based on the distance; and
adjust the target illumination value based on the illumination attenuation information.

For example, the illumination information determination module 230 is further configured to:
transform the second location information of the light source to screen coordinates to obtain second screen coordinate information;
transform the first location information of the 3D point of the target object to the screen coordinates to obtain first screen coordinate information; and
determine the distance of the light source from the 3D point of the target object based on the second screen coordinate information and the first screen coordinate information.

For example, the image rendering apparatus further includes: a set special effect superposition module configured to:
obtain initial map UV coordinates of a set special effect;
transform the initial map UV coordinates based on a current time to obtain intermediate UV coordinates;
perform polar coordinate transformation on the intermediate UV coordinates to obtain target UV coordinates; and
render set special effect based on the target UV coordinates, and superimpose the rendered set special effect onto the target object.

The image rendering apparatus described above may perform the image rendering method provided in all the foregoing embodiments of the present disclosure and has corresponding functional modules for performing the image rendering method and beneficial effects. For technical details not described in detail in this embodiment, a reference may be made to the image rendering method provided in all the foregoing embodiments of the present disclosure.

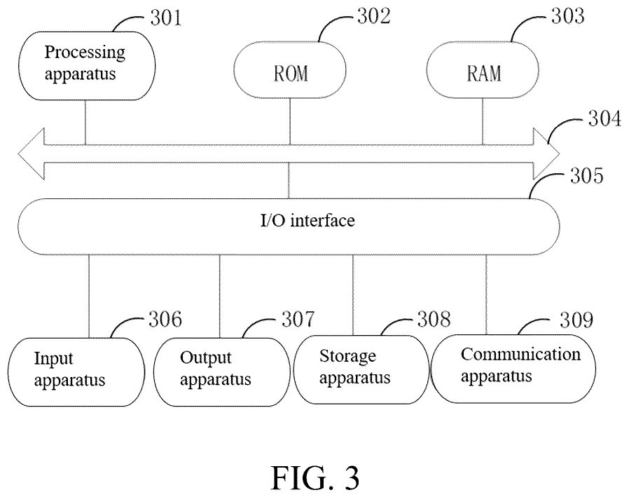

Referring to FIG. 3, FIG. 3 illustrates a schematic structural diagram of an electronic device 300 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 3 is merely an example, and should not pose any limitation to the functions and the range of use of the embodiments of the present disclosure.

As illustrated in FIG. 3, the electronic device 300 may include a processing apparatus 301 (e.g., a central processing unit, a graphics processing unit, etc.), which can perform various suitable actions and processing according to a program stored in a read-only memory (ROM) 302 or a program loaded from a storage apparatus 308 into a random-access memory (RAM) 303. The RAM 303 further stores various programs and data required for operations of the electronic device 300. The processing apparatus 301, the ROM 302, and the RAM 303 are interconnected by means of a bus 304. An input/output (I/O) interface 305 is also connected to the bus 304.

Usually, the following apparatus may be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 3 illustrates the electronic device 300 having various apparatuses, it should be understood that not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 309 and installed, or may be installed from the storage apparatus 308, or may be installed from the ROM 302. When the computer program is executed by the processing apparatus 301, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a background image; display an initial picture of a target visual effect at a preset position of the background image; control the target visual effect to gradually change from the initial picture to a target picture in response to a visual effect change instruction triggered by a user; and adjust a filter effect of the background image to allow the filter effect of the background image to gradually change from a first filter effect to a second filter effect during a change of the target visual effect.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

An embodiment of the present disclosure discloses an image rendering method, including:
obtaining an object depth map and an object normal map of a target object in an image;
determining occlusion information based on the object depth map;
determining illumination information based on the object normal map; and
rendering the target object in the image based on the occlusion information and the illumination information to obtain a target image.

For example, determining the occlusion information based on the object depth map includes:
obtaining a body depth map of a scene where the target object is located; and
determining the occlusion information based on the body depth map and the object depth map.

For example, determining the occlusion information based on the body depth map and the object depth map includes:
obtaining a near-plane depth value and a far-plane depth value of a camera;
performing linear transformation on a depth value in the object depth map based on the near-plane depth value and the far-plane depth value; and
determining the occlusion information based on the body depth map and the object depth map after the linear transformation.

For example, before obtaining the near-plane depth value and the far-plane depth value of the camera, the image rendering method further includes:
mapping a depth value in the object depth map to a set depth interval.

Performing linear transformation on the depth value in the object depth map based on the near-plane depth value and the far-plane depth value includes:
performing linear transformation on the depth value in the object depth map that is within the set depth interval based on the near-plane depth value and the far-plane depth value.

For example, the occlusion information includes an occlusion relationship between the target object and a scene body; and determining the occlusion information based on the body depth map and the object depth map includes:
determining that a 3D point of the target object is not occluded if a depth value in the body depth map is greater than a corresponding depth value in the object depth map; and
determining that the 3D point of the target object is occluded by a body if the depth value in the body depth map is less than the corresponding depth value in the object depth map.

For example, determining the illumination information based on the object normal map includes:
smoothing normal information in the object normal map;
obtaining an illumination direction of the 3D point of the target object; and
determining illumination information of the 3D point based on the illumination direction and the smoothed normal information.

For example, obtaining the illumination direction of the 3D point of the target object includes:
obtaining first location information of the 3D point of the target object and second location information of a light source; and
determining the illumination direction of the 3D point based on the first location information and the second location information.

For example, obtaining the first location information of the 3D point of the target object includes:
transforming two-dimensional surface map UV coordinates of the target object to four-dimensional cutting space coordinates, where four dimensions include an x-coordinate, a y-coordinate, a z-coordinate, and a w-coordinate;
transforming the four-dimensional cutting space coordinates to four-dimensional camera space coordinates;
performing homogeneous transformation on the four-dimensional camera space coordinates, and transforming the z-coordinate after the homogeneous transformation to the depth value in the object depth map; and
determining the first location information of the 3D point based on the transformed four-dimensional camera space coordinates.

For example, determining the illumination information of the 3D point based on the illumination direction and the smoothed normal information includes:
multiplying a vector corresponding to the illumination direction by a vector corresponding to the normal information to obtain an initial illumination value;
if the initial illumination value is greater than a first set value, multiplying the initial illumination value by a first set illumination value to obtain a target illumination value; and
if the initial illumination value is less than or equal to the first set value, multiplying the initial illumination value by a second set illumination value to obtain the target illumination value.

For example, after obtaining the target illumination value, the image rendering method further includes:
determining a distance of the light source from the 3D point of the target object;
determining illumination attenuation information based on the distance; and
adjusting the target illumination value based on the illumination attenuation information.

For example, determining the distance of the light source from the 3D point of the target object includes:
transforming the second location information of the light source to screen coordinates to obtain second screen coordinate information;
transforming the first location information of the 3D point of the target object to the screen coordinates to obtain first screen coordinate information; and
determining the distance of the light source from the 3D point of the target object based on the second screen coordinate information and the first screen coordinate information.

For example, after rendering the target object in the image based on the occlusion information and the illumination information, the image rendering method further includes:
obtaining initial map UV coordinates of a set special effect;
transforming the initial map UV coordinates based on a current time to obtain intermediate UV coordinates;
performing polar coordinate transformation on the intermediate UV coordinates to obtain target UV coordinates; and
rendering set special effect based on the target UV coordinates, and superimposing the rendered set special effect onto the target object.

It should be understood that steps may be rearranged, added or deleted using a plurality of forms of flows as shown above. For example, a plurality of steps described in the present disclosure may be performed concurrently, performed sequentially or performed in different orders as long as the desired results of the technical solutions of the present disclosure can be achieved, which will not be limited herein.

1. An image rendering method, comprising:
obtaining an object depth map and an object normal map of a target object in an image;
determining occlusion information based on the object depth map;
determining illumination information based on the object normal map; and
rendering the target object in the image based on the occlusion information and the illumination information to obtain a target image.

2. The image rendering method according to claim 1, wherein the determining occlusion information based on the object depth map comprises:
obtaining a body depth map of a scene where the target object is located; and
determining the occlusion information based on the body depth map and the object depth map.

3. The image rendering method according to claim 2, wherein the determining the occlusion information based on the body depth map and the object depth map comprises:
obtaining a near-plane depth value and a far-plane depth value of a camera;
performing linear transformation on a depth value in the object depth map based on the near-plane depth value and the far-plane depth value; and
determining the occlusion information based on the body depth map and the object depth map after the linear transformation.

4. The image rendering method according to claim 3, wherein before the obtaining a near-plane depth value and a far-plane depth value of a camera, the method further comprises:
mapping a depth value in the object depth map to a set depth interval,
wherein the performing linear transformation on a depth value in the object depth map based on the near-plane depth value and the far-plane depth value comprises:
performing linear transformation on the depth value in the object depth map that is within the set depth interval based on the near-plane depth value and the far-plane depth value.

5. The image rendering method according to claim 2, wherein
the occlusion information comprises an occlusion relationship between the target object and a scene body; and the determining the occlusion information based on the body depth map and the object depth map comprises:
determining that a three-dimensional (3D) point of the target object is not occluded, in response to determining that a depth value in the body depth map is greater than a corresponding depth value in the object depth map; and
determining that the 3D point of the target object is occluded by a body, in response to determining that the depth value in the body depth map is less than the corresponding depth value in the object depth map.

6. The image rendering method according to claim 1, wherein the determining illumination information based on the object normal map comprises:
smoothing normal information in the object normal map;
obtaining an illumination direction of the 3D point of the target object; and
determining illumination information of the 3D point based on the illumination direction and the smoothed normal information.

7. The image rendering method according to claim 6, wherein the obtaining an illumination direction of the 3D point of the object comprises:
obtaining first location information of the 3D point of the target object and second location information of a light source; and
determining the illumination direction of the 3D point based on the first location information and the second location information.

8. The image rendering method according to claim 7, wherein the obtaining first location information of the 3D point of the target object comprises:
transforming two-dimensional surface map UV coordinates of the target object to four-dimensional cutting space coordinates, wherein four dimensions comprise an x-coordinate, a y-coordinate, a z-coordinate, and a w-coordinate;
transforming the four-dimensional cutting space coordinates to four-dimensional camera space coordinates;
performing homogeneous transformation on the four-dimensional camera space coordinates, and transforming the z-coordinate after the homogeneous transformation to the depth value in the object depth map; and
determining the first location information of the 3D point based on the transformed four-dimensional camera space coordinates.

9. The image rendering method according to claim 7, wherein the determining illumination information of the 3D point based on the illumination direction and the smoothed normal information comprises:
multiplying a vector corresponding to the illumination direction by a vector corresponding to the normal information to obtain an initial illumination value;
multiplying the initial illumination value by a first set illumination value to obtain a target illumination value, in response to determining that the initial illumination value is greater than a first set value; and
multiplying the initial illumination value by a second set illumination value to obtain the target illumination value, in response to determining that the initial illumination value is less than or equal to the first set value.

10. The image rendering method according to claim 9, wherein after the obtaining the target illumination value, the method further comprises:
determining a distance of the light source from the 3D point of the target object;
determining illumination attenuation information based on the distance; and
adjusting the target illumination value based on the illumination attenuation information.

11. The image rendering method according to claim 10, wherein the determining a distance of the light source from the 3D point of the target object comprises:
transforming the second location information of the light source to screen coordinates to obtain second screen coordinate information;
transforming the first location information of the 3D point of the target object to the screen coordinates to obtain first screen coordinate information; and
determining the distance of the light source from the 3D point of the target object based on the second screen coordinate information and the first screen coordinate information.

12. The image rendering method according to claim 1, wherein after the rendering the target object in the image based on the occlusion information and the illumination information, the method further comprises:
obtaining initial map UV coordinates of a set special effect;
transforming the initial map UV coordinates based on a current time to obtain intermediate UV coordinates;
performing polar coordinate transformation on the intermediate UV coordinates to obtain target UV coordinates; and
rendering the set special effect based on the target UV coordinates, and superimposing the rendered set special effect onto the target object.

13. (canceled)

14. An electronic device, comprising:
one or more processing apparatuses; and
a storage apparatus, configured to store one or more programs,
wherein the one or more programs, when executed by the one or more processing apparatuses, cause the one or more processing apparatuses to implement an image rendering method, the image rendering method comprising:
obtaining an object depth map and an object normal map of a target object in an image;
determining occlusion information based on the object depth map;
determining illumination information based on the object normal map; and
rendering the target object in the image based on the occlusion information and the illumination information to obtain a target image.

15. A computer-readable medium, storing a computer program, wherein
the computer program, when executed by a processing apparatus, causes implementing an image rendering method, the image rendering method comprising:
obtaining an object depth map and an object normal map of a target object in an image;
determining occlusion information based on the object depth map;
determining illumination information based on the object normal map; and
rendering the target object in the image based on the occlusion information and the illumination information to obtain a target image.

16. The image rendering method according to claim 3, wherein the occlusion information comprises an occlusion relationship between the target object and a scene body; and the determining the occlusion information based on the body depth map and the object depth map comprises:
determining that a three-dimensional (3D) point of the target object is not occluded, in response to determining that a depth value in the body depth map is greater than a corresponding depth value in the object depth map; and
determining that the 3D point of the target object is occluded by a body, in response to determining that the depth value in the body depth map is less than the corresponding depth value in the object depth map.
